(19) United States
(12) Patent Application Publication
(10) Pub. No.: US 2014/0036852 A1
(43) Pub. Date: Feb. 6, 2014

(54) METHOD OF COMMUNICATION UNDER NETWORK CONDITION CONVERGING CELLULAR NETWORK AND WLAN

(71) Applicants: Gang Liu, Shanghai (CN); Kaibin Zhang, Shanghai (CN)

(72) Inventors: Gang Liu, Shanghai (CN); Kaibin Zhang, Shanghai (CN)

(73) Assignee: ALCATEL-LUCENT, Paris (FR)

(21) Appl. No.: 14/112,061

(22) PCT Filed: Mar. 30, 2012
(86) PCT No.: PCT/IB12/00903

§ 371 Date: Oct. 16, 2013

(30) Foreign Application Priority Data
May 27, 2011 (CN) 20110141890.4

(51) Int. Cl. H04W 40/04

(52) U.S. Cl. CPC H04W 40/04
USPC 370/329; 370/338

(57) ABSTRACT

A method of communication for an access control apparatus under network condition converging cellular network and WLAN, includes receiving an uplink data package from an user equipment; retrieving a destination address of the uplink data package from the received uplink data package; and determining the attribution of the destination address. If the destination address is attributed to the fixed network segment, then the uplink data package is routed to the fixed access network through Network Address Translation function. If the destination address is attributed to the mobile core network segment, then the uplink data package is routed to the mobile core network through Network Address Translation function.

### FIELD OF THE INVENTION

The present invention relates to mobile communication network, particularly to a method of communication under network condition converging cellular network and WLAN.

### BACKGROUND OF THE INVENTION

With the development of the mobile network, more and more smart terminals access mobile data traffic via the mobile communication network, which results in the growing load of the mobile access network and the core network. The capacity of mobile access network and the core network can not follow the exploding user data traffic, which results in congestion or crashing of the network, particular in the area where many subscribers frequently access data traffic. Thus the operators are looking forward for offloading solutions which can efficiently offload the mobile access network and the mobile core network.

Meanwhile, Wi-Fi technique has been rapidly developed. Due to the fact that Wi-Fi has the advantage of a wide bandwidth and low cost, more and more subscribers access mobile data traffic using the resource of WLAN (Wireless Local Area Network) according to Wi-Fi technique. Thus it is desired to offload the mobile communication network via WLAN using Wi-Fi technique.

3rd Generation Partnership Project (3GPP) standard is specifying architectures for the interworking of Wi-Fi and 3GPP networks, which is named as I-WLAN (interworking WLAN), as shown in FIG. 1. In this architecture, the following access scheme are included:

a) WLAN access: providing the subscribers with access to the WLAN and the locally connected IP network, so as to be authenticated and authorized through the 3GPP System.

b) WLAN 3GPP Access, allowing WLAN user equipments (UEs) to establish connectivity with External IP networks, such as 3G operator networks. Then, the subscribers could access 3G packet services (PS) via WLAN. Wherein, the Packet Data Network (PDN) to which the UE is to be connected is selected based on the type of the 3G PS-based service requested by the UE. The requested 3G PS-based service is identified by the UE through a WLAN-Access Point Name (W-APN).

While the UE accesses Internet services (direct IP access) and 3GPP services (3GPP IP access) concurrently, it needs to obtain two IP addresses from WLAN network and PDN, since these two kinds of services are provided by two networks with different mechanisms. The IP address obtained from WLAN network is used to connect with the local transport network, so that the data packages sent from UE can be routed to Internet. The IP address allocated by the PDN is used to establish end-to-end tunnel between the UE and the PDN, so that UE can access 3GPP services. The UE is required to have the capability of obtaining two or more IP addresses as well as establishing IPSec tunnel in this solution. These bring additional requirements to the UE and have a bad compatibility concerning the existing UEs in the network.

### SUMMARY OF THE INVENTION

The purpose of the invention is to provide a method in an access control apparatus in Wireless Local Area Network of routing data package according to the data package address. It is advantageous that requirement of the UE can be thereby simplified and reduced load of the mobile core network and the cellular access network can be achieved.

According to a first aspect of the invention, a method of communication for an access control apparatus under network condition converging cellular network and WLAN is proposed. The method comprises the following steps: receiving an uplink data package from an user equipment; retrieving a destination address of the uplink data package from the received uplink data package; determining the attribution of the destination address, if the destination address is attributed to the fixed network segment, then routing the uplink data package to the fixed access network through Network Address Translation function; if the destination address is attributed to the mobile core network segment, then routing the uplink data package to the mobile core network through Network Address Translation function.

Furthermore, the method comprises a step in which the access control apparatus performs Authentication, Authorization and Accounting (AAA) of the user equipment as an agent.

According to a second aspect of the invention, a method of downlink data communication for an access control apparatus under network condition converging cellular network and WLAN is proposed. The method comprises the following steps: receiving a downlink data package; performing Network Address Translation function, and forwarding the downlink data package to the user equipment corresponding to the downlink data package.

Thus using the above technical solution, WLAN and mobile core network can be simply converged together, and the cellular access network and the mobile core network are offloaded. Furthermore, the above technical solution simplified the requirements of the UE. UE only needs to keep one IP address, thus it is not necessary for the UE to distinguish traffic types, choose or establish complicated transport tunnel. Meanwhile the method would not influence the other network apparatus, and thus the compatibility to the existing UEs and network apparatus is enhanced.

According to a third aspect of the invention, a method of uplink data communication for an user equipment under network condition converging cellular network and WLAN is proposed. The method comprises the following steps: determining an Access Point Name corresponding to the desired data traffic; if the desired data traffic is corresponding to a first type of Access Point Name, encapsulating a data package using a first address as source address; if it is determined that the desired data traffic is corresponding to a second type of Access Point Name, encapsulating a data package using a second address as source address.

According to a fourth aspect of the invention, a method of communication for an access control apparatus under network condition converging cellular network and WLAN is proposed. The method comprises the following steps: receiving an uplink data package from an user equipment; retrieving a source address of the uplink data package from the received uplink data package; determining whether the source address is a first address allocated to the user equipment by the mobile core network or a second address allocated to the user equipment by the fixed network, if the source address is the second address, then forwarding the uplink data package via the fixed network; if the source address is the first address, then forwarding the uplink data package to the mobile core network after adding a head with the source address being the second address and the destination address being the mobile core network gateway address to the uplink data package.

According to a fifth aspect of the invention, a method of downlink data communication for an access control apparatus under network condition converging cellular network and WLAN is correspondingly proposed, wherein, the method comprises the following steps: receiving a downlink data package; determining whether the source address of the downlink data package is attributed to the mobile core network segment or the fixed network segment, if the source address is attributed to the fixed network segment, then forwarding the downlink data package directly to the user equipment corresponding to the downlink data package; if the source address is attributed to the mobile core network segment, then decapsulating the downlink data package, and retrieving an original data package with the destination address being the address allocated to the user equipment by the mobile core network, and then forwarding the original data package to the user equipment.

Consequently, using the above technical solution, the UE can be simplified even if one UE keeps two IP addresses, since it is not necessary for the UE to establish tunnel or support complicated tunnel protocol. Besides, the above technical solution brings anchor in WLAN, ensuring the mobility of the service. When UE enters or leaves WLAN, the continuity of conversation can be maintained without establishing the conversation again.

According to a sixth aspect of the invention, a method of communication based on DSMIP for an access control apparatus under network condition converging cellular network and WLAN is proposed. The method comprises the following steps: receiving an uplink data package encapsulated according to DSMIP protocol from an user equipment; detecting a destination address of an original data package in the uplink data package encapsulated according to DSMIP protocol, and determining its attribution; if the destination address is attributed to the fixed network segment, then discarding the head of DSMIP protocol encapsulation, and routing the original data package directly to the fixed access network; if the destination address is attributed to the mobile core network segment, then routing the tunnel encapsulated uplink data package to the mobile core network.

Consequently, the above technical solution can offload the cellular access network and the mobile core network in DSMIP based network.

According to the solutions in the invention, in the access control apparatus in WLAN, it can be determined to route data package via different path according to the destination address or source address of the data package. WLAN and mobile core network are simply converged together, and the cellular access network and the mobile core network are offloaded. Furthermore, the advantageous of the invention also includes: it is easy to perform uniform accounting. It can help the operators to manage the usage of WLAN, by performing authentication at the first place that the operators can manage and control.

### BRIEF DESCRIPTION OF THE DRAWINGS

FIG. 1 shows a topology of the communication network based on I-WLAN;

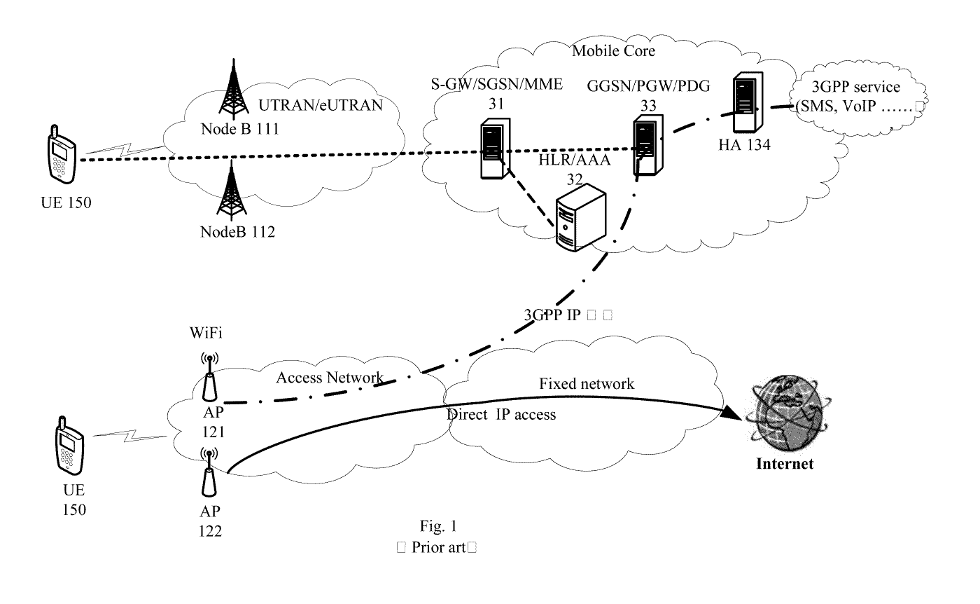

FIG. 2 shows a topology of the communication network according to one embodiment of the invention;

FIG. 3 shows a flow chart of the uplink communication method in the embodiment of FIG. 2;

FIG. 4 shows a flow chart of the downlink data communication method in the embodiment of FIG. 2;

FIG. 5 shows a topology of the communication network according to another embodiment of the invention;

FIG. 6 shows a flow chart of the uplink communication method in the embodiment of FIG. 5;

FIG. 7 shows data encapsulation of the communication method in the embodiment of FIG. 5;

FIG. 8 shows a flow chart of the downlink data communication method in the embodiment of FIG. 5;

FIG. 9 shows a topology of the communication network according to another embodiment of the invention;

FIG. 10 shows a flow chart of the downlink data communication method in the embodiment of FIG. 9.

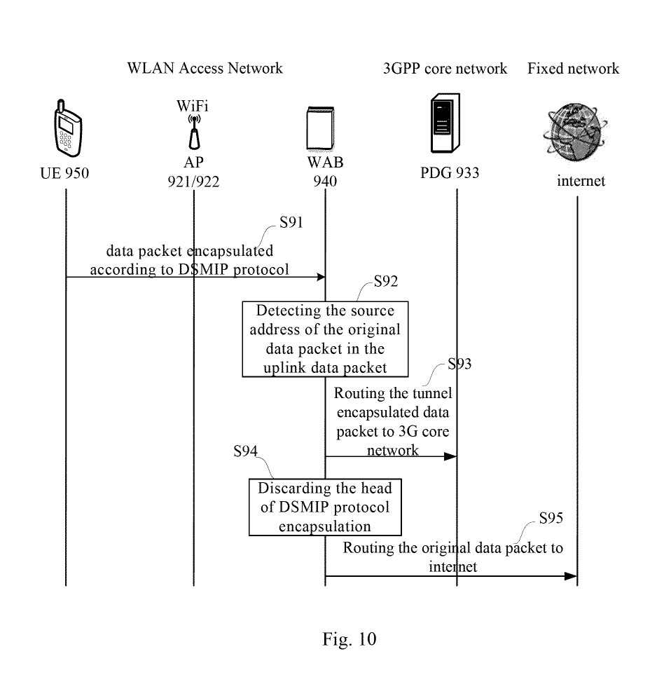

Same or similar reference numerals in the figures refer to the same or similar means.

### DETAILED DESCRIPTION OF EMBODIMENTS

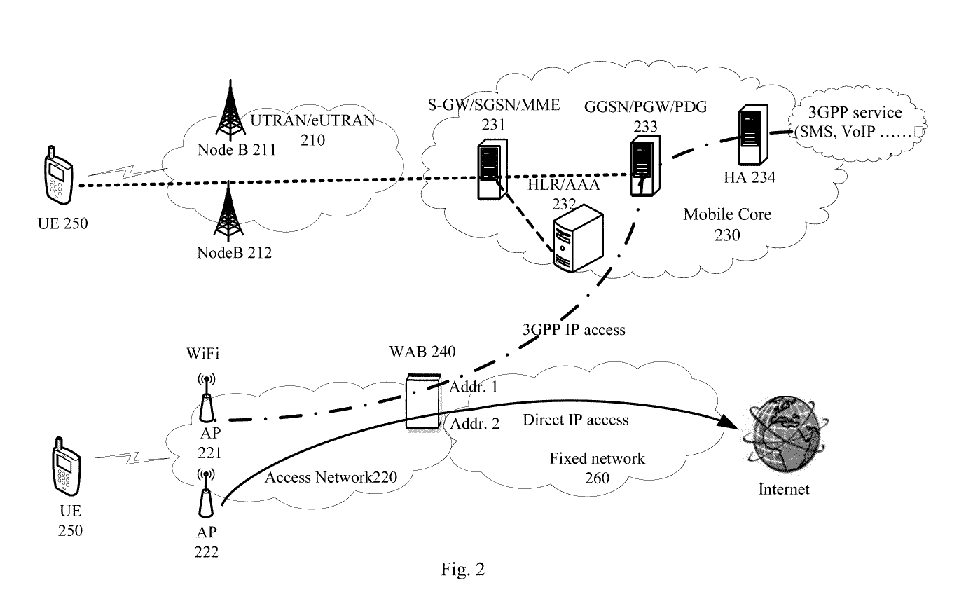

FIG. 2 shows a topology of the communication network under network condition converging cellular network and WLAN according to one embodiment of the invention. As shown in FIG. 2, under network condition converging cellular network and WLAN, Universal Terrestrial Radio Access (UTRAN) 210, WLAN access network 220, mobile core network 230, UE 250, and fixed network 260 are included.

In FIG. 2, Node B 211, 212 are shown in UTRAN 210, Wi-Fi access point 221, 222 are shown in WLAN access network 220, Serving Gateway (S-GW)/Serving GPRS Support Node (SGSN)/Mobile Management Entity (MME) 231, Home Location Register (HLR)/Authentication, Authorization and Accounting (AAA) Register 232, Gateway GPRS Service Node (GGSN)/PDN Gateway (PGW)/Packet Data Gateway (PDG) 233 and Home Agent (HA) 234 are shown in the mobile core network 230. Those skilled in the art could appreciate that only parts necessary for the understanding of the invention are shown here, the components comprised in the mobile communication network system are not limited to those shown here.

Typically, UE 250 could access 3GPP service, such as Short Message Service (SMS) or Voice over IP (VoIP), etc., through UTRAN 210, via S-GW/SGSN/MME 231 and GGSN/PGW/PDG 233, as well as HA 234.

Furthermore, a function entity of Wireless Access Broker (WAB) 240 is introduced in the embodiment, for performing the method according to the invention, so as to converge WLAN and operators' network together, extend the coverage of the network and offload the mobile access network and the mobile core network. In the following, the Wireless Access Broker is also called access control apparatus.

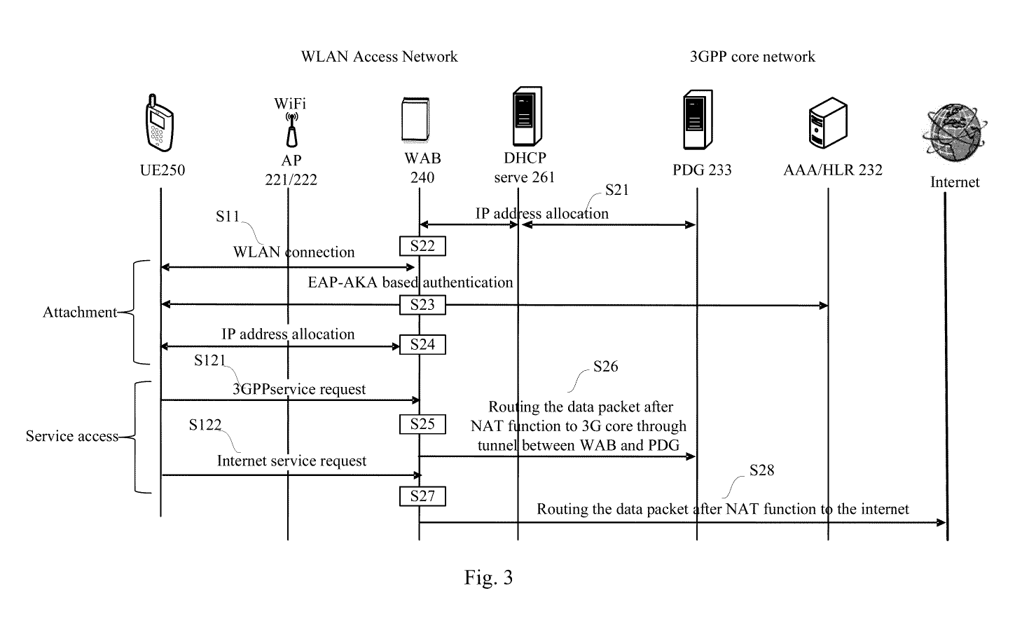

The method of communication for an access control apparatus under network condition converging cellular network and WLAN shown in FIG. 2 will be described in connection with FIG. 3. In step S21, Package Data Gateway (PDG) 233 in the 3G core network and the Dynamic Host Configuration Protocol (DHCP) (not shown in FIG. 2) respond to the request of WAB 240 and allocate IP address to it respectively. In step S22, WAB 240 obtains two IP addresses respectively from PDG 233 of the mobile core network and DHCP. Herein, as shown in FIG. 2, the address allocated to the WAB 240 by the mobile core network is labeled as Addr. 1, and the address allocated to the WAB by the fixed network is labeled as Addr. 2.

As shown in FIG. 2, in the embodiment, if the UE 250 is within the coverage of Wi-Fi access point, the UE 250 is connected to the WAB 240 via Wi-Fi access point in step S11. After the WLAN connection is established between the UE 250 and the WAB 240, the UE 250 initiates EAP-AKA based authentication. The WAB 240 performs authentication function in step S23, to make the authentication between the UE and AAA/HLR server possible. In step S24, the WAB 240 responds to the request of UE 250 and allocates local IP address to the UE 250. During the service access procedure, if the UE 250 sends a 3GPP service request in step S121, after receiving the uplink data package from the UE, the WAB 240 retrieves the destination address of the uplink data package from the received uplink data package, and determines the attribution of the destination address in step S25. If the destination address is attributed to the mobile core network segment, then the WAB 240 performs Network Address Translation (NAT) function, namely, the local IP address of the UE 250 is translated to Addr. 1 obtained by the WAB 240 from the 3G core network. In step S26, the data package after NAT function is routed to the 3G core network through the tunnel between the WAB 240 and PDG 233. If the UE 250 sends an internet service request in step S122, after receiving the uplink data package from the UE, the WAB 240 retrieves the destination address of the uplink data package from the received uplink data package, and determines the attribution of the destination address in step S27. If the destination address is attributed to the fixed network segment, then the WAB 240 performs NAT function, namely, the local IP address of the UE 250 is translated to Addr. 2 obtained by the WAB 240 from the fixed network. In step S28, the data package after NAT function is routed to the fixed network.

Those skilled in the art could appreciate that step S23 and step S24 are optional for the implementation of the invention.

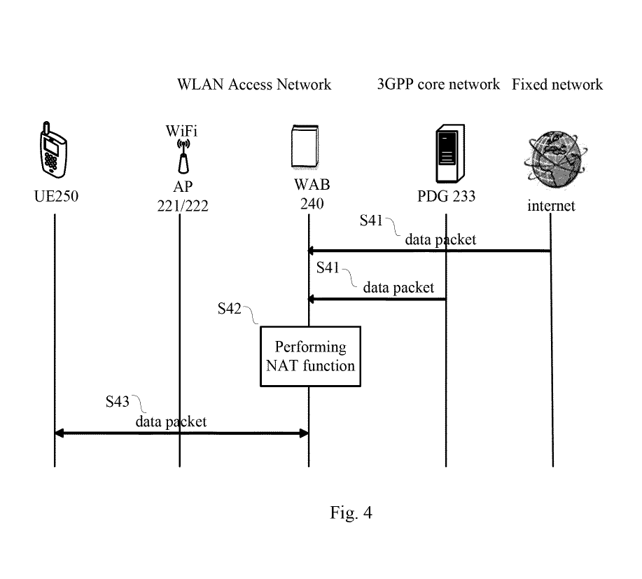

Correspondingly, FIG. 4 shows the downlink data communication method under network condition converging cellular network and WLAN shown in FIG. 2. In this embodiment, in step S41, the WAB 240 receives a downlink data package from the mobile core network or the fixed network. NAT function is performed in step S42. In step S43, the downlink data package is forwarded to the UE 250 corresponding to the downlink data package. Herein, when the UE is switched from WLAN to mobile cellular network, WAB could work as an anchor in WLAN, and forward the downlink data package of the UE by establishing tunnel to the mobility anchor of the mobile core network. Thus anchor is brought to WLAN, which ensures the mobility of service, namely, when the UE enters or leaves the WLAN, the continuity of conversation can be maintained without establishing the conversation again.

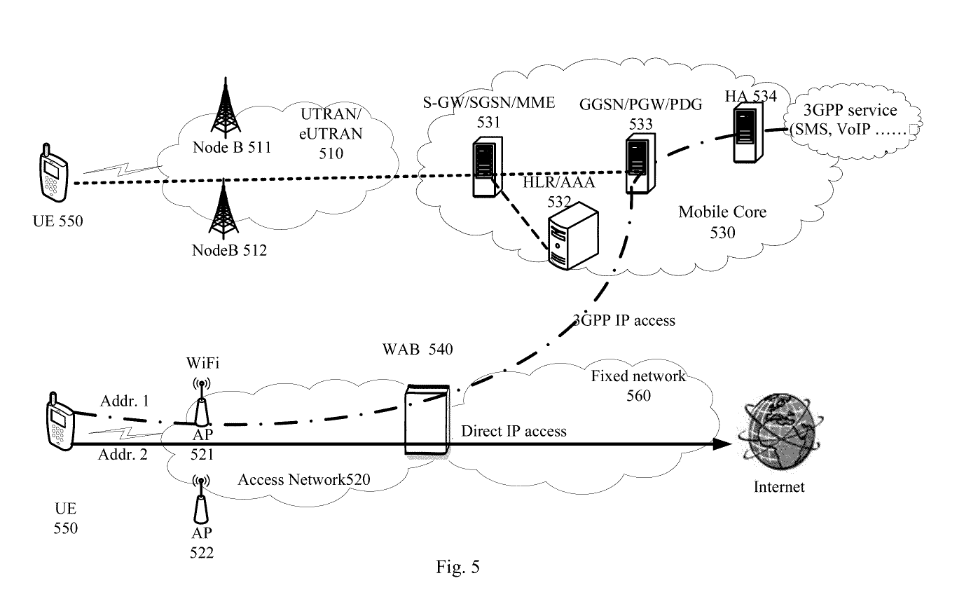

FIG. 5 shows a topology of the communication network under network condition converging cellular network and WLAN according to another embodiment of the invention. As shown in FIG. 5, under network condition converging cellular network and WLAN, UTRAN 510, WLAN access network 520, mobile core network 530, UE 550, and fixed network 560 are included.

In FIG. 5, Node B 511, 512 are shown in UTRAN 510, Wi-Fi access point 521, 522 are shown in WLAN access network 520, S-GW/SGSN/MME 531, HLR/AAA 532, GGSN/PGW/PDG 533, and HA 534 are shown in the mobile core network 530. Those skilled in the art could appreciate that only parts necessary for the understanding of the invention are shown here, the components comprised in the mobile communication network system are not limited to those shown here.

Typically, UE 550 could access 3GPP service, such as SMS or VoIP, etc., through UTRAN 510, via S-GW/SGSN/MME 531 and GGSN/PGW/PDG 533, as well as HA 534.

Furthermore, a function entity of WAB 540 is also introduced in the embodiment, for performing the method according to the invention, so as to converge WLAN and operators' network together, extend the coverage of the network and offload the mobile access network and the mobile core network. What differs from the embodiment in FIG. 2 is that the UE 550 has two IP addresses in this embodiment, which are the first address allocated to the UE by the mobile core network and the second address allocated to the UE by the fixed IP network. And correspondingly, it is no longer necessary for the WAB to select the path for routing the uplink data package according to the destination address of the uplink data package. Instead the WAB selects the path according to the source address of the uplink data package. In the following, the WAB is also called access control apparatus.

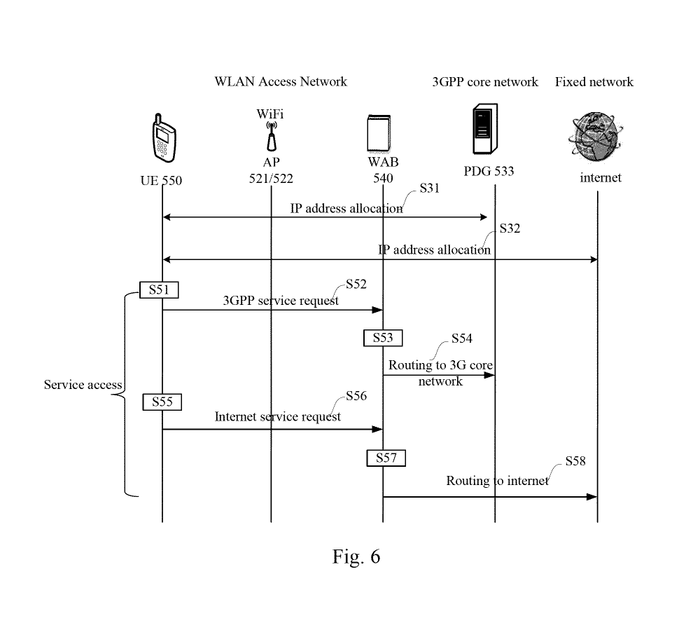

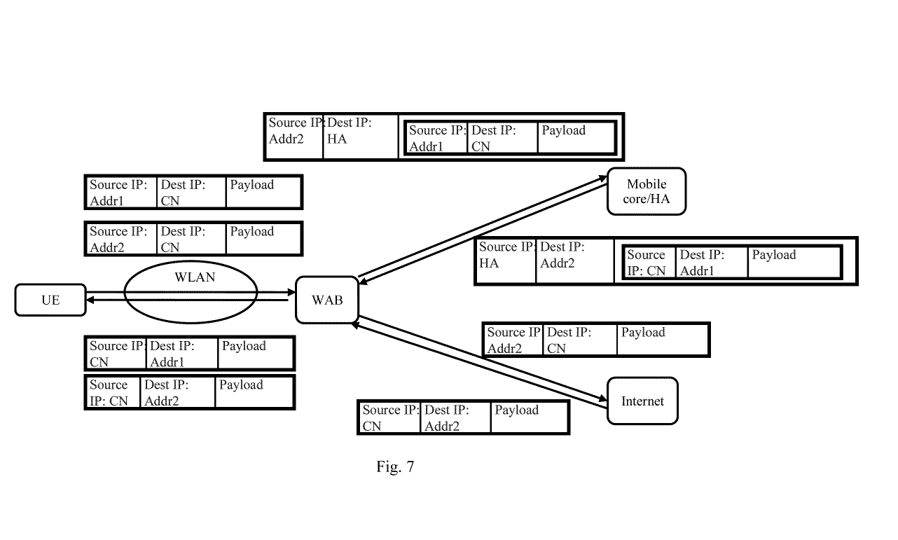

FIG. 6 shows a flow chart of the communication method according to one embodiment of the invention under the network condition shown in FIG. 5. A method of communication for an access control apparatus and an UE under network condition converging cellular network and WLAN according to one embodiment of the invention is described in connection with FIG. 6. First in step S31 and S32, the PDG 533 in the 3G core network and the fixed network respond to the request of UE 550 and allocate IP address to it respectively. Herein, as shown in FIG. 5, the address allocated to the UE 550 by the mobile core network is labeled as Addr. 1, and the address allocated to the UE 550 by the fixed network is labeled as Addr. 2. The UE 550 determines the Access Point Name (APN) corresponding to the desired data traffic in step S51. If the APN of the desired data traffic is corresponding to the mobile core network, the UE 550 encapsulates the data package using Addr. 1 as source address, and transmits the data package to the WAB 540 in step S52. If the UE 550 determines the APN of the desired data traffic is corresponding to the fixed network in step S55, then encapsulates the data package using Addr. 2 as source address, as shown in FIG. 7. The UE 550 transmits the data package to the WAB 540 in step S56.

After the WAB 540 receives an uplink data package from the UE, it retrieves the source address of the uplink data package from the received uplink data package, and determines whether the source address is Addr. 1 or Addr. 2. If the source address is determined as Addr. 1 in step S53, a head with the source address being the second address and the destination address being the mobile core network gateway address, as shown in FIG. 7, will be added to the uplink data package. Then the uplink data package is forwarded to the mobile core network in step S54. The head is used to establish a tunnel between the WAB and the mobile core network. If the source address is determined as Addr. 2 in step S57, the uplink data package will be directly forwarded via the fixed network in step S58.

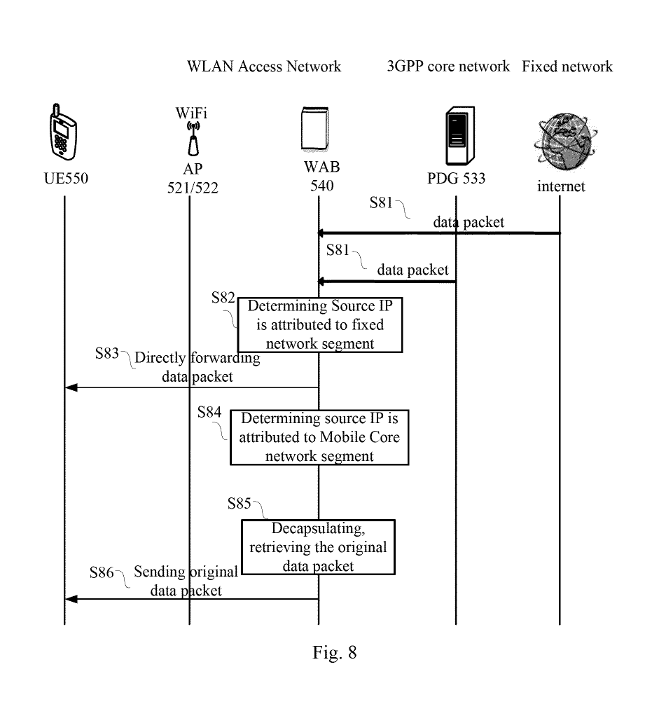

Correspondingly, FIG. 8 shows the downlink data communication method under network condition converging cellular network and WLAN shown in FIG. 5. In the above embodiments of the invention, the WAB performs the following steps for downlink data packages: in step S81, receiving a downlink data package from the fixed network or the mobile core network; in step S82, determining whether the source address of the downlink data package is attributed to the mobile core network segment or the fixed network segment, if the source address is attributed to the fixed network segment, then forwarding the downlink data package directly to the UE corresponding to the downlink data package in step S83; if the source address is determined to be attributed to the mobile core network segment in step S84, then decapsulating the downlink data package, and retrieving an original data package with the destination address being Addr.1 in step S85, and then forwarding the original data package to the UE in step S86. Thus anchor is brought into WLAN, which ensures the mobility of the service, namely when UE enters or leaves WLAN, the continuity of conversation can be maintained without establishing the conversation again.

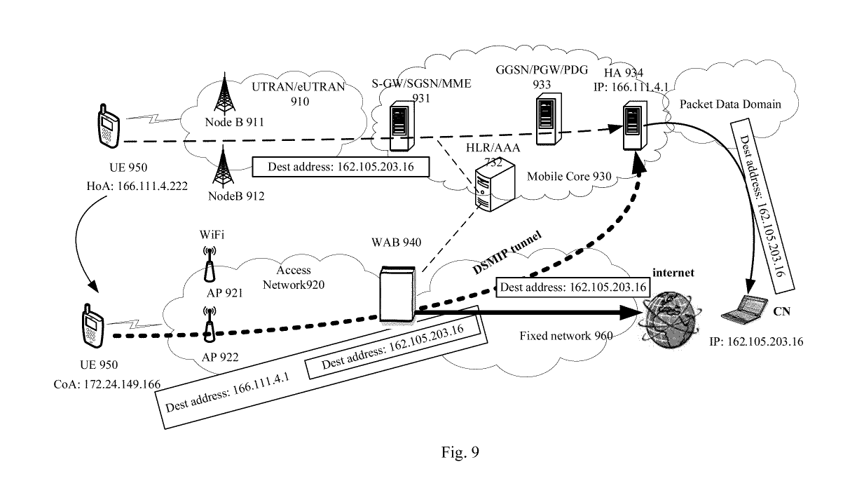

Furthermore, 3GPP Rel 8 provides a Dual Stack Mobile IP (DSMIP) mechanism which supports mobility between cellular network and WLAN. However, all the data traffic (including 3GPP service and Internet service) needs to be aggregated in the mobile core network (HA router) while implementing this mechanism. According to the taught of the invention, FIG. 9 shows a topology of the communication network under network condition converging cellular network according to another embodiment of the invention. As shown in FIG. 9, under network condition converging cellular network, UTRAN 910, WLAN access network 920, mobile core network 930, UE 950, and fixed network 960 are included.

In FIG. 9, Node B 911, 912 are shown in UTRAN 910, Wi-Fi access point 921, 922 are shown in WLAN access network 920, S-GW/SGSN/MME 931, HLR/AAA 932, GGSN/PGW/PDG 933, and HA 934 are shown in the mobile core network 930. Those skilled in the art could appreciate that only parts necessary for the understanding of the invention are shown here, the components comprised in the mobile communication network system are not limited to those shown here.

Typically, UE 950 could access 3GPP service, such as SMS or VoIP, etc., through UTRAN 910, via S-GW/SGSN/MME 931 and GGSN/PGW/PDG 933, as well as HA 934.

Furthermore, a function entity of WAB 940 is also introduced in the embodiment, for performing the method according to the invention, so as to converge WLAN and operators' network together, extend the coverage of the network and offload the mobile access network and the mobile core network. In this embodiment, UE 950 has the Home Address (HoA) of 166.111.4.222 allocated by the mobile core network. When the UE is switched to the WLAN, the WLAN allocates a Care of Address (CoA) of 172.24.149.166 to it. The destination address that the UE tries to access is 162.105.203.16. The UE 950 encapsulates data packages according to DSMIP protocol, establishes tunnel to the HA, and transmits data packages.

Wherein, the WAB 940 according to the invention perform the following steps: in step S91, receiving an uplink data package encapsulated according to DSMIP protocol from the UE 950; in step S92, detecting the destination address of the original data package in the uplink data package encapsulated according to DSMIP protocol, and determining its attribution; if the destination address is attributed to the mobile core network segment, then routing the tunnel encapsulated uplink data package to the mobile core network in step S93; if the destination address is attributed to the fixed network segment, then discarding the head of DSMIP protocol encapsulation in step S94, and routing the original data package directly to the fixed access network in step S95.

In the embodiment shown in FIG. 9, WAB 940 can retrieve the destination address 166.111.4.222 of the original data package by decapsulating the received data package. The destination address is determined to be attributed to fixed network segment. WAB 940 discards the head of DSMIP protocol encapsulation, and routes the original data package to the destination address in the fixed access network. Thus the mobile core network is offload while ensuring the mobility of the service.

Those skilled in the art could readily appreciate that, the present invention is not limited to the details of the exemplary embodiments above. Other embodiments could be used to implement the present invention without departing from the spirit or basic features of the invention. Thus, the embodiments should be considered as exemplary and non-limiting. Furthermore, the term of “comprise” does not exclude the existence of other element(s) or step(s); and indefinite article “a/an” does not exclude the “multiple” case. Terms of “a first”, “a second” are just used for give a name rather than for representing some particular order.

1. A method of communication for an access control apparatus under network condition converging cellular network and WLAN, comprising:
a. receiving an uplink data package from an user equipment;
b. retrieving a destination address of the uplink data package from the received uplink data package;
c. determining the attribution of the destination address, if the destination address is attributed to the fixed network segment, then routing the uplink data package to the fixed access network through Network Address Translation function; if the destination address is attributed to the mobile core network segment, then routing the uplink data package to the mobile core network through Network Address Translation function.

2. A method according to claim 1, wherein, the method comprises a step in which the access control apparatus performs Authentication, Authorization and Accounting of the user equipment as an agent.

3. A method according to claim 1, wherein, the method comprises a step in which the access control apparatus allocates a local area network address to the user equipment.

4. A method of downlink data communication for an access control apparatus under network condition converging cellular network and WLAN, wherein, the method comprises:
d. receiving a downlink data package;
e. performing Network Address Translation function, and forwarding the downlink data package to the user equipment corresponding to the downlink data package.

5. A method of uplink data communication for an user equipment under network condition converging cellular network and WLAN, comprising:
A. determining an Access Point Name corresponding to a desired data traffic;
B. if the desired data traffic is corresponding to a first type of Access Point Name, encapsulating a data package using a first address as source address; if it is determined that the desired data traffic is corresponding to a second type of Access Point Name, encapsulating a data package using a second address as source address.

6. A method according to claim 5, wherein, the first type of Access Point Name of the desired data traffic is corresponding to mobile core network, and the second type of Access Point Name of the desired data traffic is corresponding to fixed network;
the first address is an address allocated to the user equipment by the mobile core network; the second address is an address allocated to the user equipment by the fixed network.

7. A method of communication for an access control apparatus under network condition converging cellular network and WLAN, comprising:
i. receiving an uplink data package from an user equipment;
ii. retrieving a source address of the uplink data package from the received uplink data package;
iii. determining whether the source address is a first address allocated to the user equipment by the mobile core network or a second address allocated to the user equipment by the fixed network, if the source address is the second address, then forwarding the uplink data package via the fixed network; if the source address is the first address, then forwarding the uplink data package to the mobile core network after adding a head with the source address being the second address and the destination address being the mobile core network gateway address to the uplink data package.

8. A method of downlink data communication for an access control apparatus under network condition converging cellular network and WLAN, wherein, the method comprises:
iv. receiving a downlink data package;
v. determining whether the source address of the downlink data package is attributed to the mobile core network segment or the fixed network segment, if the source address is attributed to the fixed network segment, then forwarding the downlink data package directly to the user equipment corresponding to the downlink data package; if the source address is attributed to the mobile core network segment, then decapsulating the downlink data package, and retrieving an original data package with the destination address being the address allocated to the user equipment by the mobile core network, and then forwarding the original data package to the user equipment.

9. A method according to claim 4, wherein, when the user equipment is switched from WLAN to mobile cellular network, the access control apparatus forwards the downlink data package of the user equipment by establishing a tunnel to the mobile core network mobility anchor.

10. A method of communication based on DSMIP for an access control apparatus under network condition converging cellular network and WLAN, comprising:
a. receiving an uplink data package encapsulated according to DSMIP protocol from an user equipment;
b. detecting a destination address of an original data package in the uplink data package encapsulated according to DSMIP protocol, and determining its attribution;
c. if the destination address is attributed to the fixed network segment, then discarding the head of DSMIP protocol encapsulation, and routing the original data package directly to the fixed access network; if the destination address is attributed to the mobile core network segment, then routing the tunnel encapsulated uplink data package to the mobile core network.
